(19) United States
(12) Patent Application Publication
(10) Pub. No.: US 2021/0389820 A1
(43) Pub. Date: Dec. 16, 2021

(54) DRIVER MONITORING SYSTEM

(71) Applicant: APTIV TECHNOLOGIES LIMITED, St. Michael (BB)

(72) Inventors: Lukasz BOHDAN, Zdzieszowice (PL); Rafal MUCHA, Krakow (PL)

(21) Appl. No.: 16/897,697

(22) Filed: Jun. 10, 2020

(51) Int. Cl. G06F 3/01; H04N 5/225; H04N 5/247; H04N 5/232; B60Q 3/70

(52) U.S. Cl. CPC G06F 3/013; H04N 5/2256; B60Q 3/70; H04N 5/23219; H04N 5/247

(57) ABSTRACT

An illustrative example driver monitoring system for a motor vehicle is configured to track pupils of a driver. The system includes a first camera device including a first main optical axis, which is configured to capture a first set of images of the driver's pupils. A first illumination device includes a first main light axis and is configured to illuminate the driver's pupils during capture of the first set of images. A second camera device includes a second main optical axis and is configured to capture a second set of images of the driver's pupils. A second illumination device includes a second main light axis and is configured to illuminate the driver's pupils during capture of the second set of images. A first camera assembly includes the first camera device and the second illumination device. A second camera assembly includes the second camera device and the first illumination device.

### BACKGROUND

Driver monitoring systems are already well known in the automotive domain for detecting driver drowsiness. In general for enhanced safety function of a car, tracking pupils of a driver is needed. Solutions for tracking pupils are generally based on a camera directed at the face of the driver. Implementation of cameras for monitoring the eyes of a driver is a challenge regarding style of the body compartment of the motor vehicle, performance of capturing eye position and cost.

### SUMMARY

An illustrative example embodiment of a driver monitoring system for a motor vehicle is configured to track pupils of a driver. The system includes a first camera device including a first main optical axis. The first camera device is configured to capture a first set of images of the pupils of the driver. A first illumination device including a first main light axis is configured to illuminate the pupils of the driver during capture of the first set of images. A second camera device includes a second main optical axis and is configured to capture a second set of images of the pupils of the driver. A second illumination device includes a second main light axis and is configured to illuminate the pupils of the driver during capture of the second set of images. A first camera assembly includes the first camera device and the second illumination device. A second camera assembly includes the second camera device and the first illumination device.

The system may include an electronic control unit in communication with the first camera assembly and the second camera assembly. The electronic control unit is configured to enable together the first camera device and the first illumination device while disabling together the second camera device and the second illumination device. The first illumination device and the second illumination device may each comprise at least one infra-red light source. The first camera assembly and the second camera assembly may be both type of infra-red camera.

The first camera device and the second illumination device may be arranged from each other at a first distance less than 40 millimeters, preferably less than 35 millimeters. The second camera device and the first illumination device may be arranged from each other at a second distance less than 40 millimeters, preferably less than 35 millimeters. The first main optical axis and the first main light axis may intersect at a first angle greater than 5°, preferably greater than 10°. The second main optical axis and the second main light axis may intersect at a second angle greater than 5°, preferably greater than 10°.

An illustrative example embodiment of a vehicle driver compartment includes the driver monitoring system of any of the preceding paragraphs and a front instrument panel assembly comprising a dashboard portion facing the vehicle's driver seat. The first camera assembly and the second camera assembly are arranged with the front instrument panel. The first main optical axis and the first main light axis intersect at a driver's head zone of the driver's seat. The second main optical axis and the second main light axis intersect at the driver's head zone of the driver's seat.

The first camera assembly may be arranged within the dashboard portion.

An illustrative example embodiment of a method to operate the driver monitoring system for a motor vehicle described above, includes capturing a first set of images of the pupils of the driver with the first camera device while illuminating the pupils of the driver by the first illumination device.

The method may further comprise the step of:

capturing a second set of images of the pupils of the driver with the second camera device while illuminating the pupils of the driver by the second illumination device.

The method may include enabling together the first camera device and the first illumination device while disabling together the second camera device and the second illumination device.

The method may include enabling together the second camera device and the second illumination device while disabling together the first camera device and the first illumination device.

The method may include arranging the first camera assembly and the second camera assembly with the front panel instrument of the driver compartment of the motor vehicle, orienting the first main optical axis and the first main light axis such that the first main optical axis and the first main light axis globally intersect at the driver's face, orienting the second main optical axis and the second main light axis such that the second main optical axis and the second main light axis globally intersect at the driver's face.

The method may include orienting the first main optical axis and the first main light axis such that the first main optical axis and the first main light axis intersect at a first angle greater than 5°, preferably greater than 10°.

The method may include orienting the second main optical axis and the second main light axis, such that the second main optical axis and the second main light axis intersect at a second angle greater than 5°, preferably greater than 10°.

### BRIEF DESCRIPTION OF THE DRAWINGS

Other features, objects and advantages of at least one disclosed embodiment of the invention will become apparent from reading the detailed description that follows, and the associated drawings, which can be briefly described as follows.

FIG. 1 is a schematic diagram of a driver monitoring system according to one embodiment of the invention.

FIG. 2 is a flow chart of a method to operate the driver monitoring system according to one embodiment of the invention.

FIG. 3 is a flow chart example of the method to arranged camera device and illumination device according to the flow chart of FIG. 2.

FIG. 4 is a flow chart example of the method to capture pupils images according to the flow chart of FIG. 2.

### DETAILED DESCRIPTION

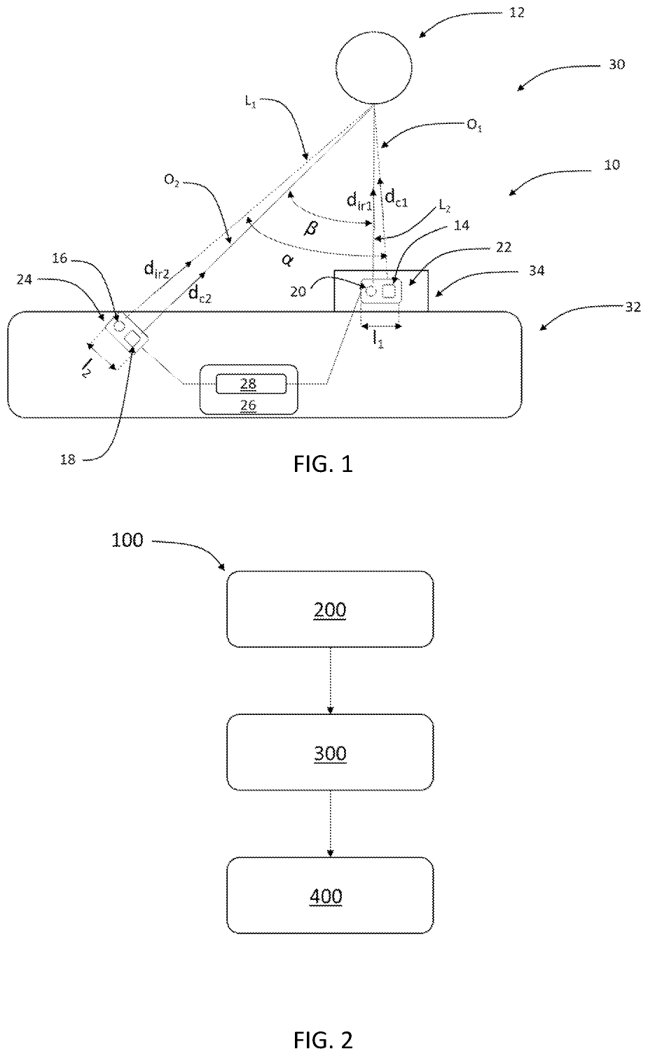

According to FIG. 1, a driver monitoring system 10 for a motor vehicle configured to track pupils of a driver 12 of the motor vehicle is shown. The circle, reference number 12, represents the face of a driver facing the front panel instrument assembly 32 of the motor vehicle, more particularly, facing the portion of the dashboard 34 wherein gauge meter as speedometer may be arranged.

The system 10 comprises a first camera device 14 including a first main optical axis O₁. The first main optical axis O₁, or first camera optical axis, is the center line of the field of view of said first camera device 14. The first camera device is configured to capture a first set of images of the pupils of the driver 12, in order, for example, to be able to determine a movement of the pupils and also the gaze direction of the eyes.

The system 10 further comprises a first illumination device 16 including a first main light axis L₁. The first main light axis L₁, or first light source optical axis, is the center line of the illumination pattern of the first illumination device 16. The first illumination device 16 is configured to illuminate the pupils of the driver 12 during a capture operation of the first set of images.

In order to get reliable information on pupils of the driver 12 of the motor vehicle, redundancy of means to capture set of images of the pupils of the driver 12 is needed such that the driver monitoring system 10 may cross images acquisition by both means to capture set of images. Thus, the system further comprises a second camera device 18 including a second main optical axis O₂. The second main optical axis O₂, or second camera optical axis, is the center line of the field of view of said second camera device 18. The second camera device is configured to capture a second set of images of the pupils of the driver 12.

The system 10 further comprise a second illumination device 20 including a second main light axis L₂. The second main light axis L₂, or second light source optical axis, is the center line of the illumination pattern of the second illumination device 20. The second illumination device 20 is configured to illuminate the pupils of the driver 12 during a capture operation of the second set of images.

To provide camera devices and illumination devices that make the integration of the driver monitoring system 10 easily, camera devices and illuminations devices should be provided as two camera assembly comprising each a camera device and an illumination device. In addition, for dark pupil tracking method, angulation between a camera device and its associated illumination device is an issue. Dark pupil tracking requires higher angulation between camera device and its associated illumination device than a bright pupil tracking method. An associated illumination device with a camera device is the illumination device that illuminates driver face during the camera device operation. Thus, the camera device and its associated illumination device have to be far enough from each other.

According to one embodiment of the invention, the driver monitoring system 10 comprises a first camera assembly 22 comprising the first camera device 14 and the second illumination device 20, and a second camera assembly 24 comprising the second camera device 18 and the first illumination device 16. As such, the first camera device 14 is physically assembled with the second illumination device 20, but the first camera device 14 is operationally associated with the first illumination device 16. As such, the second camera device 18 is physically assembled with the first illumination device 16, but the second camera device 18 is operationally associated with the second illumination device 20.

The driver monitoring system 10 further comprises an electronic control unit 26 in electrical communication with the first camera assembly 22 and with the second camera assembly 24. The electronic control unit 26 is configured to synchronize the behavior of the first camera device 14 with the first illumination device 16. The electronic control unit 26 is also configured to synchronize the behavior of the second camera device 18 with the second illumination device 20.

During the first set of images acquisition operation of the first camera device 14 of the first camera assembly 22, the electronic control unit 26 enables the first illumination device 16 of the second camera assembly 24 to illuminate or flash the pupils of a driver 12 of the motor vehicle.

During the second set of images acquisition operation of the second camera device 18 of the second camera assembly 24, the electronic control unit 26 enables the second illumination device 20 of the first camera assembly 22 to illuminate or flash the pupils of a driver 12 of the motor vehicle.

As such, the electronic control unit 26 comprises switching means 28 for enabling together the first camera device 14 and the first illumination device 16 while disabling together the second camera device 18 and the second illumination device 20. The electronic control unit 26 may be a microcontroller wherein the switching means are digital means providing data communication between the microcontroller and both first camera assembly 22 and second camera assembly 24.

To avoid too much disturbances of the driver of the motor vehicle, the first illumination device 16 and the second illumination device 20 comprise each at least one infra-red light source that is activated during capture operation of a set of images of the pupils of the driver 12. Preferably, the first camera assembly 22 and the second camera assembly 24 are both type of infra-red camera such that camera packaging assembly is minimized Generally, to get acceptable camera assembly dimension according to the constraint of the vehicle's cabin design, the first camera device 14 and the second illumination device 20 are arranged from each other at a first distance 11 less than 40 millimeters, preferably less than 35 millimeters, especially when said first camera assembly is arranged within the dashboard portion 34. Additionally, the second camera device 18 and the first illumination device 16 are arranged from each other at a second distance 12 less than 40 millimeters, preferably less than 35 millimeters.

In order to provide a reliable dark pupil tracking method, according to a general distance between the front panel instrument assembly 32 and the pupils of the driver 12 of the motor vehicle, it is recommended that the first main optical axis O₁ and the first main light axis L₁ intersect at a first angle α greater than 5°, even preferably greater than 10°.

According to a cross operation of capturing set of images of the pupils of the driver, the second main optical axis O₂ and the second main light axis L₂ intersect at a second angle 13 greater than 5°, even preferably greater than 10°.

According to FIG. 1, a vehicle driver compartment 30 comprises the driver monitoring system 10 is shown. The vehicle driver compartment 30 comprises the front panel instrument assembly 32 including the dashboard portion 34 facing the vehicle's driver seat (not shown) wherein stands the driver 12.

The first camera assembly 22 and the second camera assembly 24 are arranged with the front panel instrument 32. Both may be integrated inside the front panel assembly, not visible by the driver 12, such that both camera assembly 22, 24 are placed behind and opaque area of the front panel instrument 32 in order to be able to capture sets of images of the pupils of the driver 12 of the motor vehicle.

Arrangement with the front panel assembly 32 is such that the first main optical axis O₁ and the first main light axis L₁ intersect at the driver's head zone of the driver's seat; and the second main optical axis O₂ and the second main light axis L₂ intersect at the driver's head zone of the driver's seat. More particularly, the first camera assembly 22 is arranged with the dashboard portion 34.

The first camera device 14, part of the first camera assembly 22, is arranged such that its first main optical axis O₁ is pointing in a first optical direction d_{c1} toward the face of the driver 12 of the motor vehicle. The first illumination device 16, part of the second camera assembly 24, is arranged such that its first main light axis L₁ is pointing in a second light direction dᵢᵣ₂ toward the face of the driver 12 of the motor vehicle. The second camera device 18, part of the second camera assembly 24, is arranged such that its second main optical axis O₂ is pointing in a second optical direction d_{c2} toward the face of the driver 12 of the motor vehicle. The second illumination device 20, part of the first camera assembly 22, is arranged such that its second main light axis L₂ is pointing in a first light direction did toward the face of the driver 12 of the motor vehicle.

According the FIG. 2, a method 100 to operate the driver monitoring system 10 for a motor vehicle as described at FIG. 1 is shown. The method comprises three main steps. At first, the method comprises a first step of providing 200 a first camera assembly 22 comprising a first camera device 14 and a second illumination device 20, and a second step of providing 300 a second camera assembly 24 comprising a second camera device 18 and a first illumination device 16. Then the method 100 comprises a third step of capturing 400 set of images of the pupils of the driver 12 by means of the first camera assembly 22 and of the second camera assembly 24.

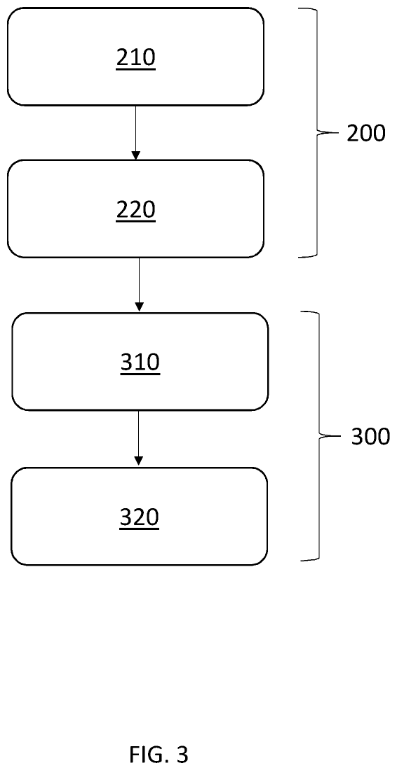

According to FIG. 3, the first step of providing 200 the first camera assembly 22 comprising a step of providing 210 the first camera device 14 and the second illumination device 20 distanced by a first distance l₁ less than 40 millimeters, preferably less than 35 millimeters; and a step of assembling 220 the first camera device 14 and the second illumination device 20 such that the first distance 11 is less than 40 millimeters, preferably less than 35 millimeters. An infra-red type of camera assembly may suit with the above steps.

According to FIG. 3, the second step of providing 300 the second camera assembly 24 comprising a step of providing 310 the second camera device 18 and the first illumination device 16 distanced by a second distance l₂ less than 40 millimeters, preferably less than 35 millimeters; and a step of assembling 320 the second camera device 18 and the first illumination device 16 such that the second distance l₂ is less than 40 millimeters, preferably less than 35 millimeters. An infra-red type of camera assembly may suit with the above steps.

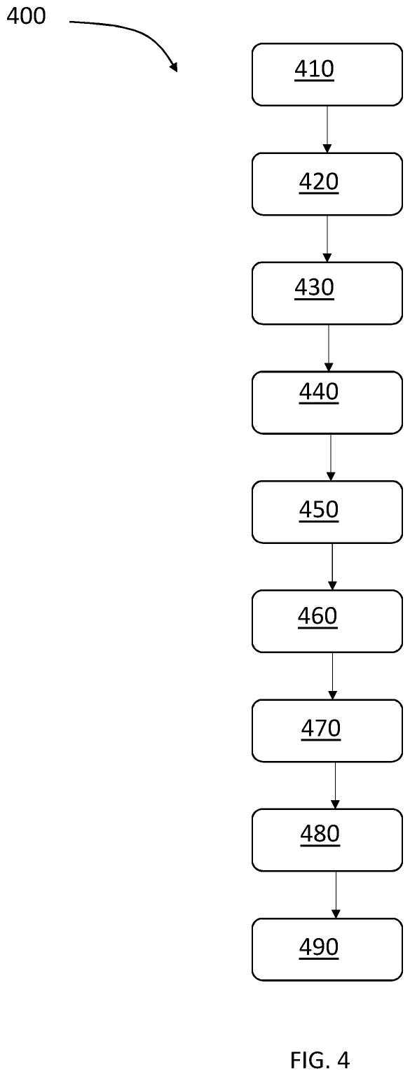

According to FIG. 4, the step of capturing 400 set of images of the pupils of the driver 12 comprises several step. A first step comprises a step of arranging 410 the first camera assembly 22 and the second camera assembly 24 with the front panel instrument 32 of the driver compartment 30 of the motor vehicle. More particularly, the first camera assembly 22 is arranged within the dashboard portion 34 of the front panel instrument 32 wherein gauge meter as speedometer is located. Then another step comprises a step of orienting 420 the first main optical axis O₁ and the first main light axis L₁ such that the first main optical axis O₁ and the first main light axis L₁ globally intersect at the driver's face. In addition, for redundancy operation, another step comprises a step of orienting 430 the second main optical axis O₂ and the second main light axis L₂ such that the second main optical axis O₂ and the second main light axis L₂ globally intersect at the driver's face.

To get an efficient dark pupil tracking method, the step of capturing 400 set of images of the pupils of the driver 12 comprising a step of orienting 440 the first main optical axis O₁ and the first main light axis L₁ such that the first main optical axis O₁ and the first main light axis L₁ intersect at a first angle α greater than 5°, preferably greater than 10°. In addition, the step of capturing 400 set of images of the pupils of the driver 12 comprising a step of orienting 450 the second main optical axis O₂ and the second main light axis L₂, such that the second main optical axis O₂ and the second main light axis L₂ intersect at a second angle 13 greater than 5°, preferably greater than 10°.

Then for cross operating method, the step of capturing 400 set of images of the pupils of the driver 12 comprising a step of enabling 460 together the first camera device 14 and the first illumination device 16 while disabling together the second camera device 18 and the second illumination device 20, and then the step of capturing 400 set of images of the pupils of the driver 12 comprises a step of capturing 470 a first set of images of the pupils of the driver 12 with the first camera device 14 while illuminating the pupils of the driver 12 by the first illumination device 16.

In addition, following said two previous steps, the step of capturing 400 set of images of the pupils of the driver 12 comprising a step of enabling 480 together the second camera device 18 and the second illumination device 20 while disabling together the first camera device 14 and the first illumination device 16, and then the step of capturing 400 set of images of the pupils of the driver 12 comprises a step of capturing 490 a second set of images of the pupils of the driver 12 with the second camera device 18 while illuminating the pupils of the driver 12 by the second illumination device 20.

The preceding description is illustrative rather than limiting in nature. Variations and modifications may become apparent to those skilled in the art based on the above description. The scope of legal protection provided to the invention can only be determined by studying the following claims.

1. A driver monitoring system for a motor vehicle configured to track pupils of a driver of the motor vehicle, said system comprising:
a first camera device including a first main optical axis, said first camera device being configured to capture a first set of images of the pupils of the driver;
a first illumination device including a first main light axis, said first illumination device being configured to illuminate the pupils of the driver during capture of the first set of images;
a second camera device including a second main optical axis, said second camera device being configured to capture a second set of images of the pupils of the driver;
a second illumination device including a second main light axis, said second illumination device being configured to illuminate the pupils of the driver during capture of the second set of images;
a first camera assembly comprising the first camera device physically assembled with the second illumination device; and
a second camera assembly comprising the second camera device physically assembled with the first illumination device, the second camera assembly arranged and oriented relative to the first camera assembly such that:
the first main optical axis of the first camera device intersects with the first main light axis of the first illumination device;
the second main optical axis of the second camera device intersects with the second main light axis of the second illumination device; and
at least one of:
the first camera device is arranged at a first distance less than 40 millimeters from the second illumination device, or
the second camera device is arranged at a second distance of less than 40 millimeters from the first illumination device.

2. The system according to claim 1, comprising an electronic control unit in electrical communication with the first camera assembly and with the second camera assembly, said electronic control unit being configured to enable together the first camera device and enabling the first illumination device while disabling together the second camera device and disabling the second illumination device.

3. The system according to claim 1, wherein
the first camera device is arranged at the first distance from the second illumination device.

4. The system according to claim 3, wherein
the second camera device is arranged at the second distance from the first illumination device.

5. The system according to claim 1, wherein
the first main optical axis and the first main light axis intersect at a first angle greater than 5°; and
the second main optical axis and the second main light axis intersect at a second angle greater than 5°.

6. A system for a motor vehicle comprising:
a driver's seat;
a first camera device including a first main optical axis, said first camera device being configured to capture a first set of images of pupils of a driver;
a first illumination device including a first main light axis, said first illumination device being configured to illuminate the pupils of the driver during capture of the first set of images;
a second camera device including a second main optical axis, said second camera device being configured to capture a second set of images of the pupils of the driver;
a second illumination device including a second main light axis, said second illumination device being configured to illuminate the pupils of the driver during capture of the second set of images;
a first camera assembly comprising the first camera device physically assembled with the second illumination device;
a second camera assembly comprising the second camera device physically assembled with the first illumination device; and
a front panel instrument assembly comprising a dashboard portion facing the driver's seat, the first camera assembly, and the second camera assembly, the first camera assembly being arranged and oriented relative to the second camera assembly such that:
the first main optical axis intersects with the first main light axis at a driver's head zone of the driver's seat;
the second main optical axis intersects with the second main light axis at the driver's head zone of the driver's seat; and
at least one of:
the first camera device is arranged at a first distance less than 40 millimeters from the second illumination device, or
the second camera device is arranged at a second distance of less than 40 millimeters from the first illumination device.

7. The system of claim 6, wherein the first camera assembly is arranged within the dashboard portion.

8. A method of operating a driver monitoring system, said method comprising:
illuminating pupils of a driver of a motor vehicle using a first illumination device that is physically assembled with a second camera device in a second camera assembly, the first illumination device having a first main light axis, and the second camera device having a second main optical axis; and
capturing, while the first illumination device illuminates the pupils, a first set of images of the pupils using a first camera device that is physically assembled with a second illumination device in a first camera assembly, the first camera device having a first main optical axis, the second illumination device having a second main light axis, the first camera assembly arranged and oriented relative to the second camera assembly such that the first main light axis intersects with the first main optical axis and the second main light axis intersects with the second main optical axis, and at least one of:
the first camera device arranged at a first distance less than 40 millimeters from the second illumination device; or
the second camera device arranged at a second distance of less than 40 millimeters from the first illumination device.

9. The method according to claim 8, further comprising:
capturing, while illuminating the pupils of the driver by the second illumination device, a second set of images of the pupils of the driver using the second camera device.

10. The method according to claim 8, wherein capturing the first set of images of the pupils further comprises:
enabling the first camera device that is physically assembled with the second illumination device together with enabling the first illumination device that is physically assembled with the second camera device while disabling the second camera device together with disabling the second illumination device.

11. The method according to claim 9, wherein capturing the second set of images further comprises:
enabling the second camera device that is physically assembled with the first illumination device together with the second illumination device that is physically assembled with the first camera device while disabling the first camera device together with the first illumination device.

12. (canceled)

13. The method according to claim 8, comprising orienting the first camera assembly and the second camera assembly such that:
the first main optical axis intersects with the first main light axis at a first angle greater than 5′; and
the second main optical axis intersects with the second main light axis at a second angle greater than 5°.

14. The method according to claim 8, wherein capturing the first set of images of the pupils further comprises:
capturing the first set of images using the first camera assembly and the second camera assembly while the first camera assembly and the second camera assembly are behind an opaque area of a front panel instrument of the motor vehicle.

15. The method according to claim 8, wherein capturing the first set of images of the pupils further comprises:
capturing the first set of images using the first camera assembly and the second camera assembly while the first camera assembly and the second camera assembly are arranged such that:
the first main optical axis intersects the first main light axis at a first angle greater than 10°; and
the second main optical axis intersects the second main light axis at a second angle greater than 10°.

16. The method according to claim 8, wherein capturing the first set of images of the pupils further comprises:
capturing the first set of images using an electronic control unit in electrical communication with the first camera assembly and with the second camera assembly such that the electronic control enables the first camera device together with the first illumination device while disabling the second camera device together with the second illumination device together.

17. The system of claim 6, further comprising:
an electronic control unit in electrical communication with the first camera assembly and with the second camera assembly, the electronic control unit configured to enable the first camera device together with the first illumination device while disabling the second camera device together with the second illumination device.

18. The system of claim 6, wherein:
the first camera assembly is positioned at a first location in the vehicle driver compartment that includes a speedometer of the motor vehicle and in front of the driver's seat, and
the second camera assembly is positioned at a second location that is different from the first location and with an orientation that causes the first main optical axis to intersect with the first main light axis and the second main optical axis to intersect with the second main light axis.

19. The system of claim 18, wherein the second camera assembly is positioned at the second location with the orientation such that:
the first main optical axis intersects the first main light axis at a first angle greater than 10°; and
the second main optical axis intersects the second main light axis at a second angle greater than 10°.

20. (canceled)

21. (canceled)
